(19) United States
(12) Patent Application Publication
(10) Pub. No.: US 2018/0374394 A1
(43) Pub. Date: Dec. 27, 2018

(54) SECURITY SEAL

(71) Applicant: Demir SABANCI, Istanbul (TR)

(72) Inventor: Demir SABANCI, Istanbul (TR)

(21) Appl. No.: 15/739,151

(22) PCT Filed: Jul. 22, 2016
(86) PCT No.: PCT/TR2016/050231

§ 371 Date: Dec. 21, 2017

(30) Foreign Application Priority Data
May 12, 2016 (TR) 2016/06251

(51) Int. Cl. G09F 3/03

(52) U.S. Cl. CPC G09F 3/0311; G09F 2003/0208

(57) ABSTRACT

The invention is related to a plastic security seal having space on its body for information (serial number, barcode, or radio frequency identity), used for exposure and evidence, which has self destructive legs when tampered with ill intentions used in order to lock plastic cases.

### CROSS REFERENCE TO RELATED APPLICATIONS

This application is the national phase entry of International Application No. PCT/TR2016/050231, filed on Jul. 22, 2016, which claims priority from Turkish patent application no. 2016/06251 filed on May 12, 2016, the entire contents of which are incorporated herein by reference.

### TECHNICAL FIELD OF THE INVENTION

The invention is related to a plastic security seal having space on its body with information (serial number, barcode, or radio frequency identity), used for exposure and evidence, which has self destructive legs when tampered with ill intentions used in order to lock plastic cases.

### BACKGROUND OF THE INVENTION

Security seals are used as preventive measures against the tampering or opening of tote boxes. Security seals vary in terms of their usage and where they are used on. The most commonly used seals are pull up type security seals. As it has been defined in the patent document numbered US20060119111, a cable is inserted into a mechanism with apertures and threads, therefore enabling sealing.

Another known seal type is the plastic, box seal. The sealing process is carried out by being inserted in slot. The patent application document numbered SG165217A1 can be given as an example to this type of seal. It has a single stem and a weakened portion with apertures between the leg and the informative section. They are used to seal plastic boxes. The hook like end is inserted into the locking mechanism provided in the box and in the case that it is opened, it is used as evidence against tampering as the seal is deformed or broken from the plastic section.

FIG. 1, shows security seal for a plastic box which is similar to the known state of the art. The product having two locking ends with arrow like tips comprise a section that enables said product to be kept at a vertical angle. This section also comprises a small area on which an information tag (serial number, logo) can be adhered; however as this tag area is very small, information tags such as barcode, serial number tags do not fit on it and as this body section is vertical sometimes, the seal can be broken without tampering during handling or carriage. Due to these reasons, the seal cannot meet the requirements exactly. Moreover additional equipment is required in order to dispose the information section.

### SUMMARY OF THE INVENTION

The invention subject to the application is a plastic box seal having two stems with ends shaped like arrows. It is aimed to be used as a security precaution against tampering and for locking of boxes such as plastic cases, containers or cargo boxes. Due to the design of the box on which the seal is to be used, the box can only be locked with a two stemmed seal or the sealing process can only be carried out with a pull up type seal where the cables/strips of these seals are inserted into the holes and are locked.

The boxes that are locked are piled on top of each other and therefore the body part of the invention has been positioned horizontally; when the box is looked from the top, the information tag section on the seal can be easily observed and the information section located at the top section of the body is embedded into the box. As a result, the seal is prevented to be accidentally damaged during piling the boxes on top of each other and shipping.

The invention comprises two stems, and after the stems are inserted into the hole, the tabs on the arrow like end prevent the seal from coming back out of the hole and as the end part is shaped like a hemi-sphere, the sealing process is easier. A weakened area has been provided between the information area and the stems. In case of tampering the stems remain inside the holes, however the body is broken away from the weakened areas. By this means it is aimed to prevent interventions carried out by bad intentioned people.

The security seals that are used need to be disposed following usage. In order to facilitate this, another weakened are has been provided at the mid section of the information area. Following usage, the body is twisted from the disposal section and therefore can be easily broken.

In addition to this, the plastic cases need to also be sealed from both sides. As a result of the production of the novel security seal as shown in FIG. 4, the sealing process has been improved in terms of taking less time.

### BRIEF DESCRIPTION OF THE DRAWINGS

FIG. 1 (Prior Art) is a security seal sample for a plastic box

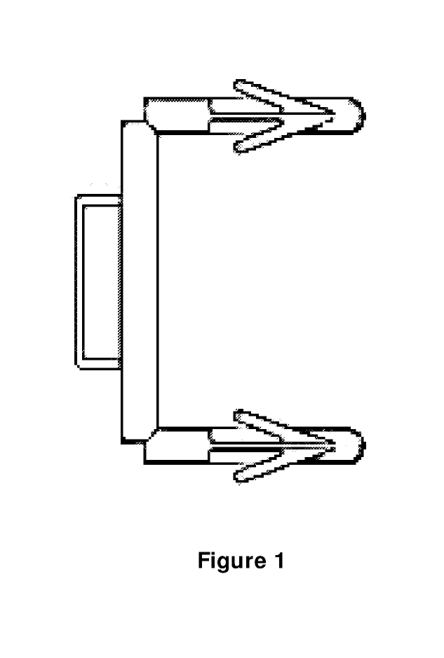

FIG. 2 is the front, side, top and isometric view of the invention

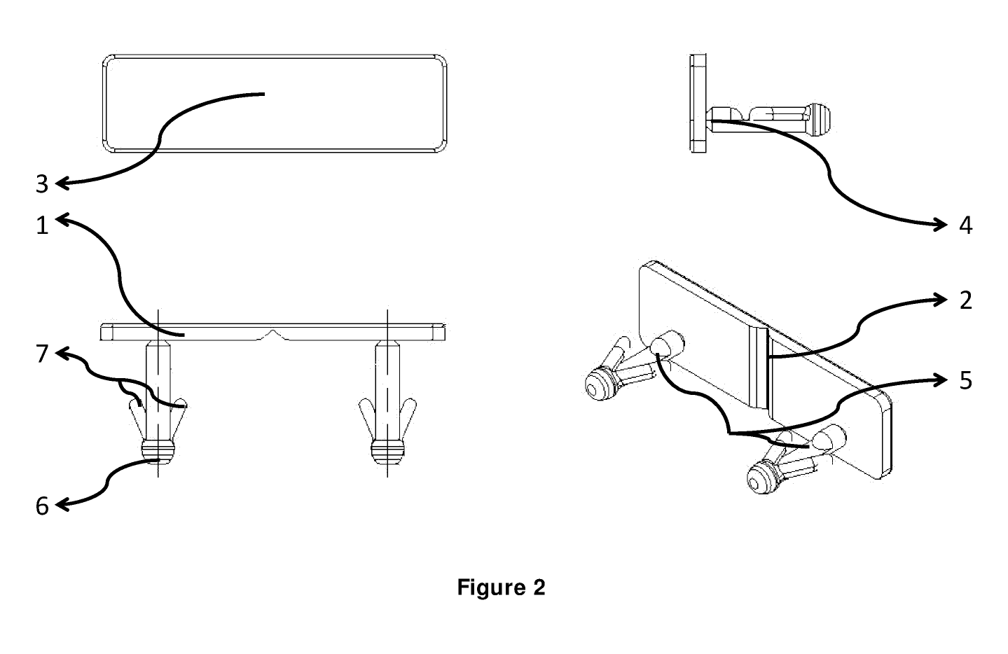

FIG. 3 is the plastic case sample sealed by the invention

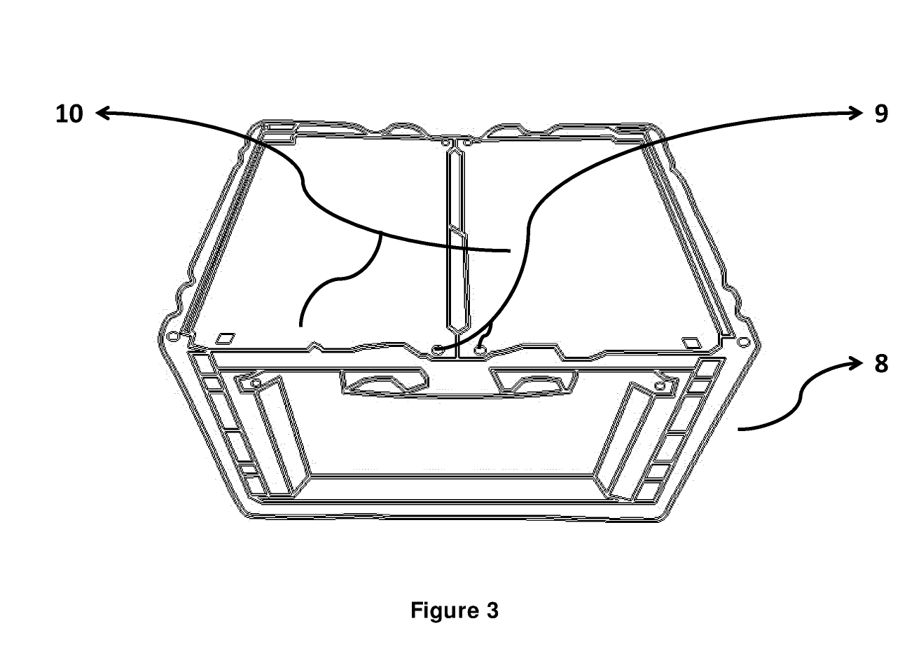

FIG. 4 is the seal subject to the invention which has been produced as a pair.

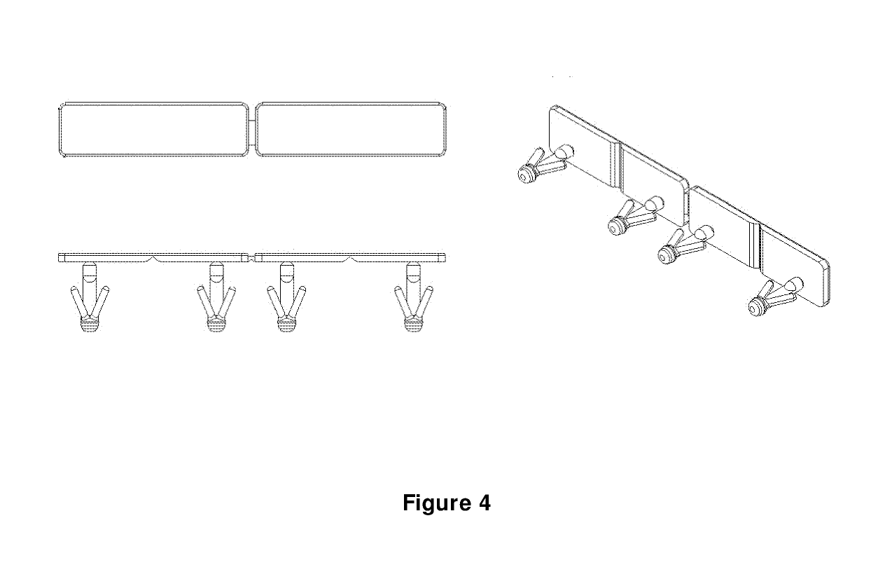

The parts and sections in the figures have each been numbered and their description has been provided below.

### DEFINITION OF THE ASPECTS/SECTIONS/PARTS FORMING THE INVENTION

11. Body
12. Body Disposal Section
13. Information Area
14. Seal Disposal Nodes
15. Stems
16. End Part
17. Tabs
18. Plastic box
19. Holes
20. Covers

### DETAILED DESCRIPTION OF THE INVENTION

The structure of the invention is formed of a body (1) placed horizontally, a transverse body disposal section (2) located at the mid section of the lower part of the body, an information area (3) located at the top part of the body, stems (5) coupled to the body (1) and seal disposal nodes (4) located between the body (1) and the stems (5). The stems (5) are semi flat and the end parts (6) of the stems are shaped like a hemisphere comprising tabs (7) on the arrow like tip.

The information area (3) provided on the body (1) enables the inscription of applications such as barcodes, serial numbers, and radio frequency identity tag and besides the locking process; it also acts like identification for the locked boxes.

The primary aim of the invention is to provide a seal for plastic cargo boxes. The end parts (6) provided on the stems (5) and the tabs (7) on the end parts are inserted into the holes (9) located on both sides of the plastic box (8), therefore the tabs (6) at the end parts (6) enable the stems (5) to be irreversibly locked on the plastic box (8).

When the covers (10) provided on the plastic box (8) is opened, the stems (5) remain inside the holes (9); however as the strength of the seal disposal nodes (4) located between the stems (6) and the body are weak, they break apart and are divided into 3 parts, being the body (1) and the stems (5). By this means it can be observed that the plastic box (8) has been opened.

What is claimed is:

1. A security seal comprising: a body, a horizontal body disposal section located at a mid section of a lower part of the body, an information area located at a top part of the body, a plurality of stems coupled to the body and a plurality of seal disposal nodes located between the body and the plurality of stems.

2. The security seal according to claim 1, wherein the horizontal body disposal section has a cross section with a weakened strength as compared to the body in order for the body to be disposed of following usage and the information area is placed horizontally at the top part of the body.

3. The security seal according to claim 1, wherein the plurality of stems are semi flat and ends of the plurality of stems have a hemispherical shape; and behind an end section the plurality of stems comprise tabs, wherein the tabs have an arrow head shape.

4. The security seal according to claim 1, wherein two stems are provided and the seal disposal nodes have a weakened strength at sections coupled to the body.

5. A security seal comprising two identical seals, wherein the two identical seals are placed adjacent to each other and joined along a short side of each identical seal; and
an information area is located at a top part of the security seal;
wherein, each of the two identical seals comprises a horizontal body disposal section located at a mid section of a lower part of the body, a plurality of stems coupled to the body and a plurality of seal disposal nodes located between the body and the plurality of stems.
